(19) United States
(12) Patent Application Publication
(10) Pub. No.: US 2014/0140561 A1
(43) Pub. Date: May 22, 2014

(54) SYSTEM AND METHOD FOR SECURING HEADPHONE TRANSDUCERS USING MAGNETS WITH A PROTRUSION AND DEPRESSION TO PREVENT MOVEMENT IN THE SECURING PLANE

(71) Applicant: Monster, LLC, Las Vegas, NV (US)

(72) Inventors: Noel Lee, Las Vegas, NV (US); Kendrew Lee, Tsing Yi (HK)

(73) Assignee: Monster, LLC, Las Vegas, NV (US)

(21) Appl. No.: 13/682,562

(22) Filed: Nov. 20, 2012

(51) Int. Cl. H04R 1/10

(52) U.S. Cl. CPC H04R 1/1091
USPC 381/370

(57) ABSTRACT

A system for securing audio transducers to each other or to another surface allowing the relative positions of the transducers or the transducer and the surface to remain fixed while secured.

### CROSS-REFERENCE TO RELATED APPLICATION

This application claims the benefit of the filing date of U.S. Provisional Application Ser. No. 61/562955 filed on Nov. 22, 2011, the disclosure of which is incorporated by reference as if fully set forth herein.

### TECHNICAL FIELD

The technical field is electrical engineering/audio-visual technology.

### BACKGROUND ART

The present invention relates generally to a system and method for securing headphone transducers and, more particularly, to a system and method for securing headphone transducers through the implementation of coupling means, such as, for example, magnets, hooks, hooks and loops, etc. Such systems are not new. See, e.g., U.S. Pat. No. 7,436,974, U.S. Pat. No. 7,693,295, and U.S. Pat. No. 8,189,843, whose disclosures are incorporated herein by reference. However, existing systems that only use flat magnets as securing means are not ideal. When the outer surfaces of the transducers, or the outer surface of the transducer and the outer surface of the coupling base, are substantially planar, the transducer or transducers risk being decoupled under shear forces. Such forces are commonplace in today's uses of such inventions, for example when working out or during inadvertent collisions in increasingly crowded areas. Magnets are a very convenient coupling means, but an improvement is needed to accommodate the aforementioned environments.

### SUMMARY OF THE INVENTION

The system comprises a first transducer device having a first mechanical housing, which has an outer surface and an inner surface. A first coupling device is affixed to the outer surface of the first mechanical housing of the first transducer device. A second transducer device has a second mechanical housing, which has an outer surface and an inner surface, A second coupling device is affixed to the outer surface of the second mechanical housing of the second transducer device. The first coupling device is coupled to the second coupling device when in close proximity to each other, such that the inner surfaces of the first and second mechanical devices are opposed to each other. Where the first and second coupling devices are magnets, the improvement comprises of a protrusion on the outer surface of the first transducer and a corresponding depression on the outer surface of the second transducer wherein the protrusion and depression are similarly shaped and positioned such that when the first coupling device is secured to the second coupling device, the protrusion nests inside the depression in such a way as to prevent relative movement of the first and second transducers in the plane of their respective outer surfaces.

Alternatively, the system comprises a transducer device having a mechanical housing, which has an outer surface and an inner surface. A coupling device is affixed to the outer surface of the mechanical housing of the transducer device. A coupling base has an outer surface and an inner surface. The coupling device is coupled to the coupling base when in close proximity to each other. Where the coupling device and coupling base are magnets, the improvement comprises a protrusion on the outer surface of the transducer and a corresponding depression on the outer surface of the coupling base wherein the protrusion and depression are similarly shaped and positioned such that when the coupling device is secured to the coupling base, the protrusion nests inside the depression in such a way as to prevent relative movement of the transducer and the coupling base in the plane of their respective outer surfaces. In an alternative embodiment the depression may reside on the outer surface of the transducer and the protrusion may reside on the outer surface of the coupling base.

### BRIEF DESCRIPTION OF THE DRAWINGS

FIG, 1 depicts a front perspective view of one embodiment of the invention.

FIG. 2 depicts a rear perspective view of one embodiment of the invention.

FIG. 3 depicts a front view of one embodiment of the invention.

FIG. 4 depicts a rear vie of one embodiment of the invention.

FIG. 5 depicts a side view of the two transducer devices of the invention in the process of magnetic attachment.

FIG. 6 depicts a side view of the two transducer devices of the invention as attached.

FIGS. 7-9 depict perspective views of three alternate protrusion-and-depression arrangements for maintaining the relative positions of the transducer devices tile attached.

### DESCRIPTION OF THE EMBODIMENTS

The following describes preferred embodiments. However, the invention s not limited to those embodiments. The description that follows is for purpose of illustration and not limitation. Other systems, methods, features and advantages will be or will become apparent to one with skill in the art upon examination of the following figures and detailed description. It is intended that all such additional systems, methods, features and advantages be included within this description, be within the scope of the inventive subject matter, and be protected by the accompanying claims.

Wherever possible, the numbering of elements is consistent throughout the figures. A lack of numbering does not necessarily imply an element is not represented in the figure. Its labeling may be omitted to reduce clutter or improve clarity where appropriate,

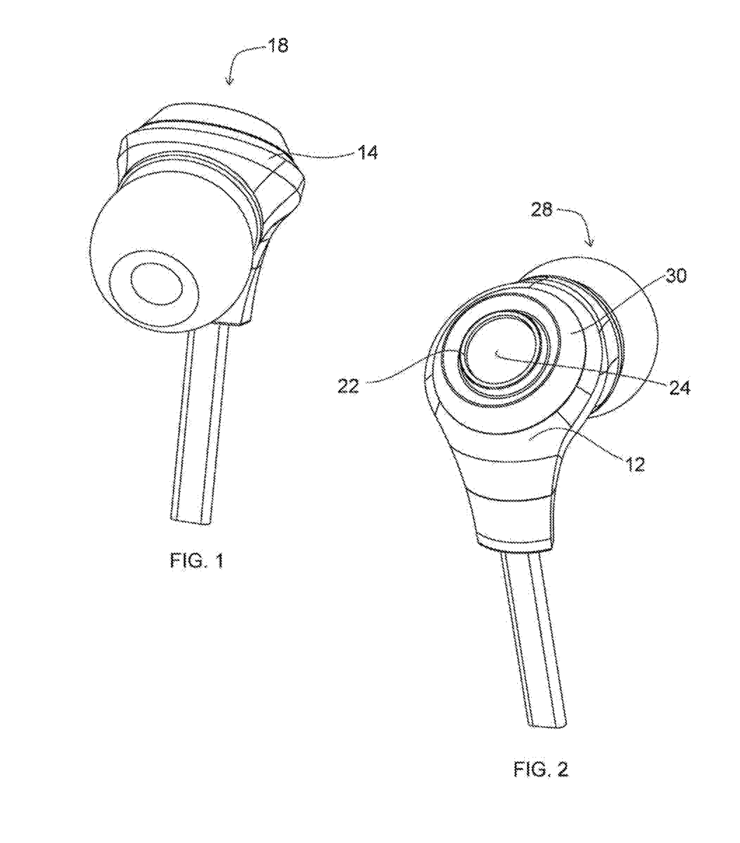

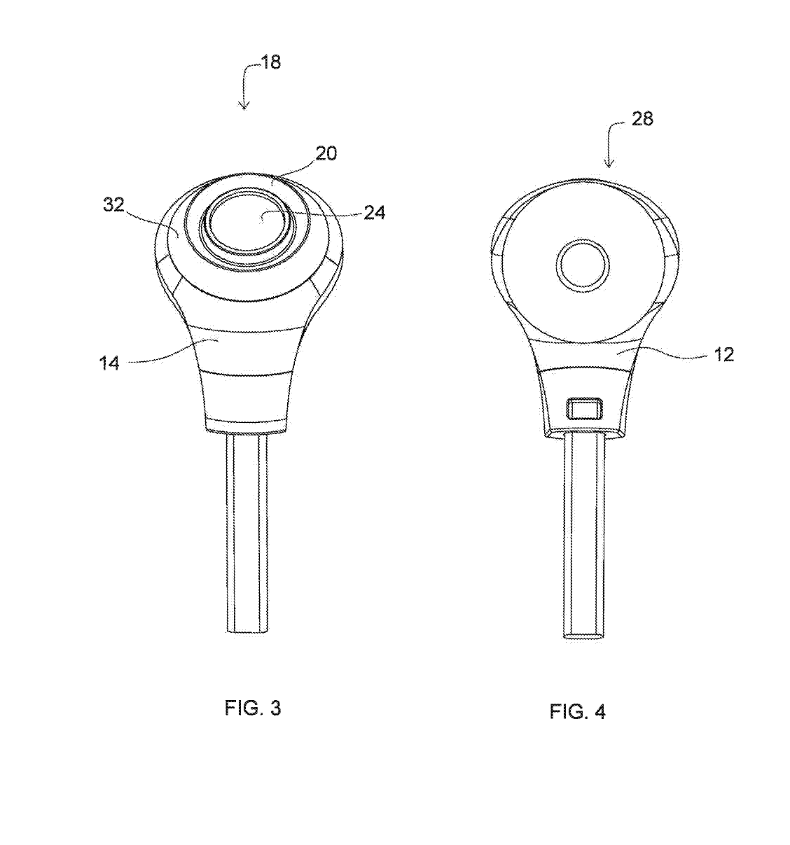

FIGS. 1-6 show various perspectives of headphone transducer devices. In the depicted embodiment, the transducer devices can be inserted into a user's ear.

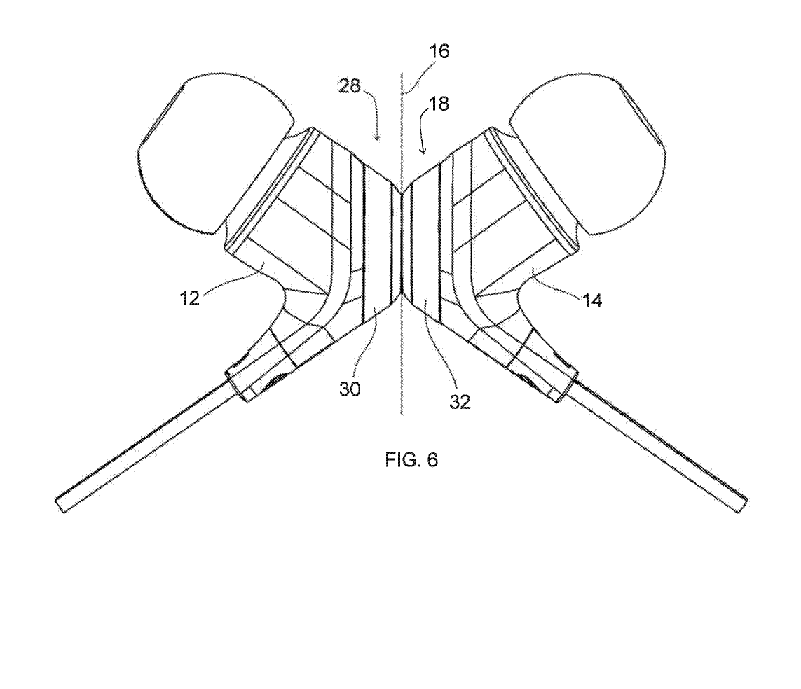

The outer surface 30 of the mechanical housing 12 of the first transducer 28 comprises a protrusion, which, as depicted, is a small ring 22 attached to a magnet 24. The outer surface 32 of the mechanical housing 14 of the second transducer 18 comprises a depression, which, as depicted, is a large outer ring 20. When the first and second transducers 28 and 18 are coupled, the large ring 20 and the small ring 22 are nested together in order to secure the headphone transducers 28 and to keep them from moving relative to each other in the plane 16. The plane 16, shown in FIG. 6, is between and parallel to the surfaces of the magnets 24, and is perpendicular to the surface of the drawings sheet on which the figure appears.

It will be appreciated by those skilled in the art that the bond between the magnets 24 is not permanent, thereby allowing the user to pull apart or separate the ear-bud transducers, 28 and 18 and place them back into the ears of the user without difficulty.

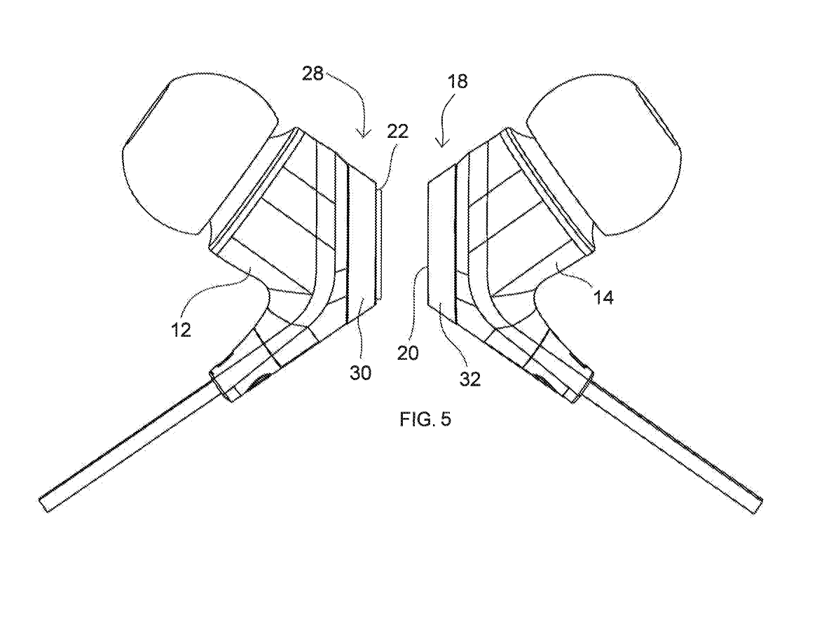

FIG. 5 illustrates the headphone transducers in the process of being attached. The outer surfaces 30 and 32 of the first and second transducers 28 and 18 are pointed towards each other as they are being attached. The nested smaller outer circle 22 is brought together to nest within the larger outer circle 20. Magnets 24 attract each other enabling the securing of the headphone, wherein the polarity of the magnets is opposite and attractive, such that the magnets are attracted to each other when in close proximity.

FIG. 6 illustrates the headphone transducers 28 and 18 securely attached. The nested circles 20 and 22 are intertwined to securely hold the headphone transducers 28 and 18 together.

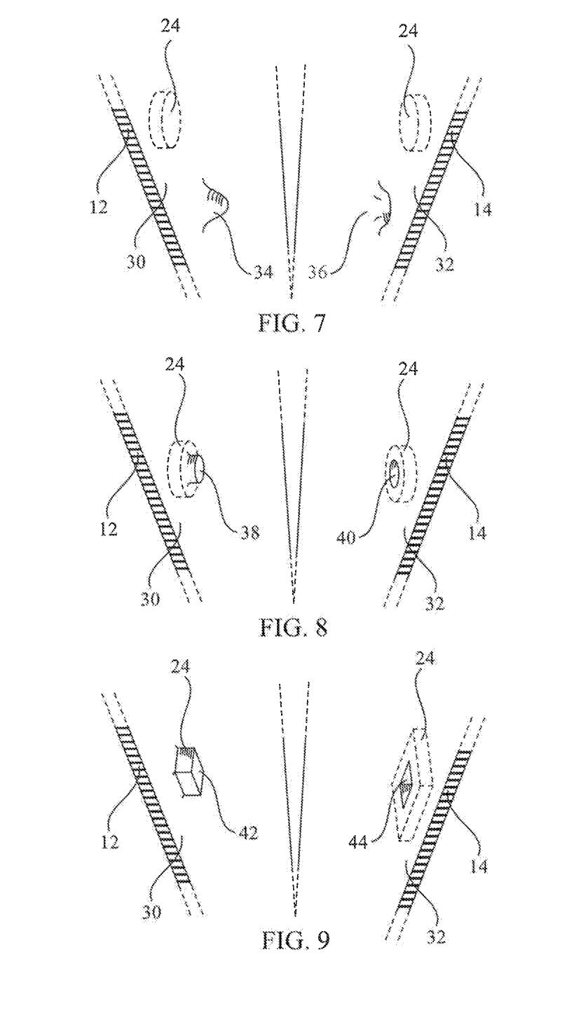

FIGS. 7-9 shows three alternative embodiments of protrusions and depressions. FIG. 7 depicts the protrusion as a mound 34 and the depression as a dimple 36 wherein there are magnets 24 offset and embedded into the first and second mechanical housings 12 and 14. FIG. 8 depicts the protrusion as an elliptical column 38 and the depression as an elliptical cavity 40 wherein there are magnets 24 underneath and embedded into the first and second mechanical housings 12 and 14. FIG. 9 depicts the protrusion as a rectangular column 42 and the depression as a rectangular cavity 44 wherein there are the rectangular column 42 and rectangular cavity further comprise magnets 24.

### INDUSTRIAL APPLICABILITY

The technical field is consumer electronics and listening devices.

What is claimed is:

1. An improved system for securing headphones, the system comprising:
a. a first transducer device having a first mechanical housing, the first mechanical housing having an outer surface and an inner surface;
b. a first coupling device affixed to the outer surface of the first mechanical housing of the first transducer device;
c. a second transducer device having a second mechanical housing, the second mechanical hosing having an outer surface and an inner surface;
d. a second coupling device affixed to the outer surface of the second mechanical housing of the second transducer device;
wherein the first coupling device is coupled to the second coupling device when in close proximity to each other, such that the inner surfaces of first and second mechanical devices to each other;
wherein the first and second coupling devices are magnets, wherein the polarity of the magnets are opposite and attractive, such that the magnets are attracted to each other when in close proximity;
wherein the improvement comprises:
e. a protrusion on the outer surface of the first mechanical housing;
f. a depression on the outer surface of the second mechanical housing; and
wherein the protrusion and depression are similarly shaped and positioned such that when the first coupling device is secured to the second coupling device, the protrusion nests inside the depression in such a way as to prevent relative movement of the first and second transducers in the plane of their respective outer surfaces.

2. The system of claim 1, wherein the protrusion is formed by the first coupling device, and the depression is formed by the second coupling device.

3. The system of claim 1, wherein the first and second transducer devices comprise at least one of: an ear-clip; and an ear-bud.

4. An improved system for securing headphones, the system comprising:
a. a transducer device having a mechanical housing, the mechanical housing having an outer surface and an inner surface;
b. a coupling device affixed to the outer surface of the mechanical housing of the transducer device;
c. a coupling base having an outer surface and an inner surface, the coupling base comprising a bonding layer at least partially disposed on the inner surface such that the coupling base is permanently or removably affixed to an exterior surface of an object;
wherein the coupling device is secured to the coupling base when in close proximity;
wherein the coupling device and the coupling base are magnets, wherein the polarity of the magnets are opposite and attractive, such that the magnets are attracted to each other when in close proximity;
wherein the improvement comprises:
d. a. protrusion on the outer surface of the mechanical housing;
e. a depression on the outer surface of the coupling base; and
wherein the protrusion and depression are similarly shaped and positioned such that when the coupling device is secured to the coupling base, the protrusion nests inside the depression in such a way as to prevent relative movement of the transducer and the coupling base in the plane of their respective outer surfaces.

5. The system of claim 4, wherein the protrusion is formed by the coupling device, and the depression is formed by the coupling base.

6. The system of claim 4, wherein the transducer device comprises at least one of: an ear-clip; and an ear-bud.

7. The system of claim 4, wherein the bonding layer is an adhesive layer.

8. The system of claim 4, wherein the bonding layer is a magnet and the exterior surface of the object is magnetically attractive.

9. An improved system for securing headphones, the system comprising:
a. a transducer device having a mechanical housing, the mechanical housing having an outer surface and an inner surface;
b. a coupling device affixed to the outer surface of the mechanical housing of the transducer device;
c. a coupling base having an outer surface and an inner surface, the coupling base comprising a bonding layer at least partially disposed on the inner surface such that the coupling base is permanently or removably affixed to an exterior surface of an object;
wherein the coupling, device is secured to the coupling base when in close proximity;
wherein the coupling device and the coupling base are magnets, wherein the polarity of the magnets are opposite and attractive, such that the magnets are attracted to each other when in close proximity;
wherein the improvement comprises:
d. a depression on the outer surface of the mechanical housing;
e. a protrusion on the outer surface of the coupling base; and
wherein the protrusion and depression are similarly shaped and positioned such that when the coupling device is secured to the coupling base, the protrusion nests inside the depression in such a way as to prevent relative movement of the transducer and the coupling base in the plane of their respective outer surfaces.

10. The system of claim 9, wherein the depression is formed by the coupling device, and the protrusion is formed by the coupling base.

11. The system of claim 9, wherein the transducer device comprises at least one of: an ear-clip; and an ear-bud.

12. The system of claim 9, wherein the bonding layer is an adhesive layer.

13. The system of claim 9, wherein the bonding layer is a magnet and the exterior surface of the object is magnetically attractive.
